(19) United States
(12) Patent Application Publication
(10) Pub. No.: US 2007/0181470 A1
(43) Pub. Date: Aug. 9, 2007

(54) Apparatus and method for sorting container components

(75) Inventor: Jerry W. Young, Platte City, MO (US)

Correspondence Address: BLACKWELL SANDERS PEPER MARTIN LLP, 4801 Main Street, Suite 1000, KANSAS CITY, MO, 64112, US

(73) Assignee: Huhtamaki Consumer Packaging

(21) Appl. No.: 11/350,368

(22) Filed: Feb. 8, 2006

(51) Int. Cl. B07C 5/00

(52) U.S. Cl. 209/552; 209/644

(57) ABSTRACT

The sorting device is providing for sorting container components from a random orientation in about three axes of the container components to a sorted orientation which may be random about one axis of the container component. The apparatus includes a conveyor which extracts container components from a storage receptacle with the withdrawn components being oriented randomly about two axes. An ejector device is provided that will sense the orientation of the container components about one axis and eject those which are improperly oriented.

### BACKGROUND

For many automated packaging processes, it is important that certain packaging components be positioned in a desired orientation in order for the next step of the process to function properly and efficiently. For example, in an automated process of placing container lids on a container receptacle, the lids need to be positioned correctly or a downstream machine may not function properly and/or efficiently. There are two basic ways to solve orientation problems. One is through manual labor and another is through automated sorters that may be complicated in construction and operation. In the manual method, a worker visually inspects the lids and if one is not oriented correctly the worker can manually place the lid in the correct orientation. The use of manual labor may be undesirable in many respects and particularly because of the cost involved with manual labor. Also, manual labor may limit the speed at which sorting can be accomplished and if the required desired speed of sorting is too fast, mistakes may be made. With the use of mechanical sorters, they may be overly complicated or may not be sufficiently universal to handle enough different types of lid to warrant the capital investment. Therefore, there exists a need for an apparatus and method for orienting container components in a certain desirable orientation which can orient cheaply, quickly and with little involved manual labor.

### SUMMARY OF THE INVENTION

The present invention involves the provision of an automated orienting device for orienting randomly oriented container components. The apparatus and method involves sorting the components which may be randomly oriented in three axes first to a two axes random orientation and then sensing which of two possible orientations the component may be in about one axis and rejecting those which are indicated as being improperly oriented in one of the two orientations. The device includes a receptacle for containing container components, a conveyor system for conveying container components from the receptacle and initially reorienting container components from random three axes orientation to a two axes orientation. The conveyor system transports the container components from the receptacle to a station for sensing one of two possible orientations, for example, right side in, right side out. When an improper orientation of the two possible orientations is sensed, the improperly orientated container component is ejected from the conveyor system in response to a signal from the orientation sensor. Properly oriented components may then be transferred to downstream processing equipment as desired.

The present invention also involves the provision of a method of sorting container components from a random orientation in three axes, first to a random orientation in two axes sensing one of two possible orientations about two axes, for example, right side out, right side in and ejecting container components which are determined by a sensor to be not properly oriented about the one axis. The ejected improperly oriented container components may be returned to the receptacle for reorienting.

### DETAILED DESCRIPTION OF THE DRAWINGS

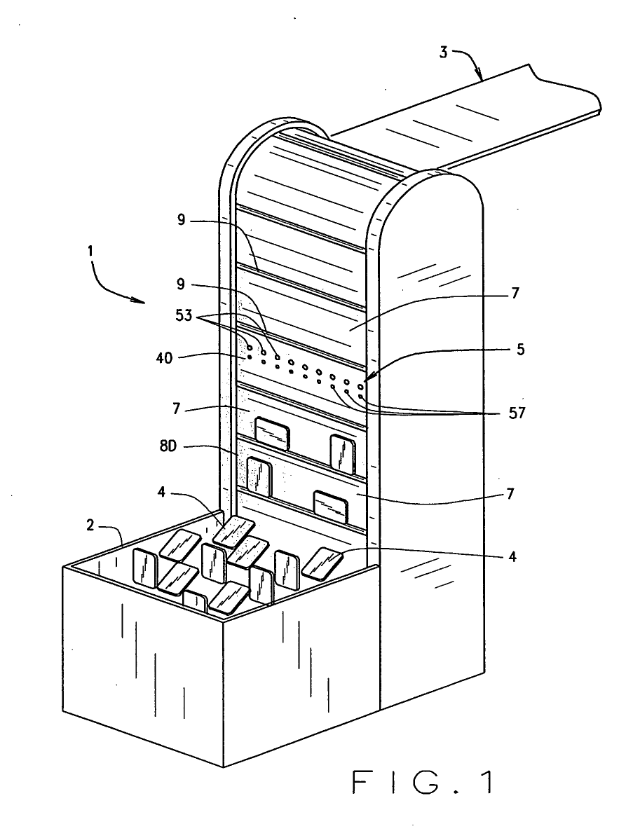

FIG. 1 is a perspective view of an orienting apparatus shown from the side of a container component receptacle.

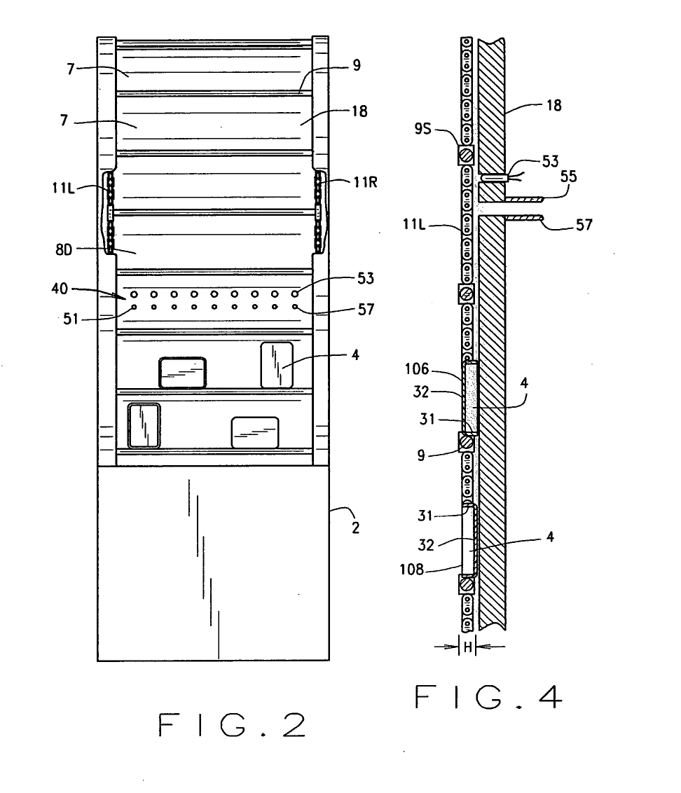

FIG. 2 is a front elevation view of the orienting apparatus of FIG. 1.

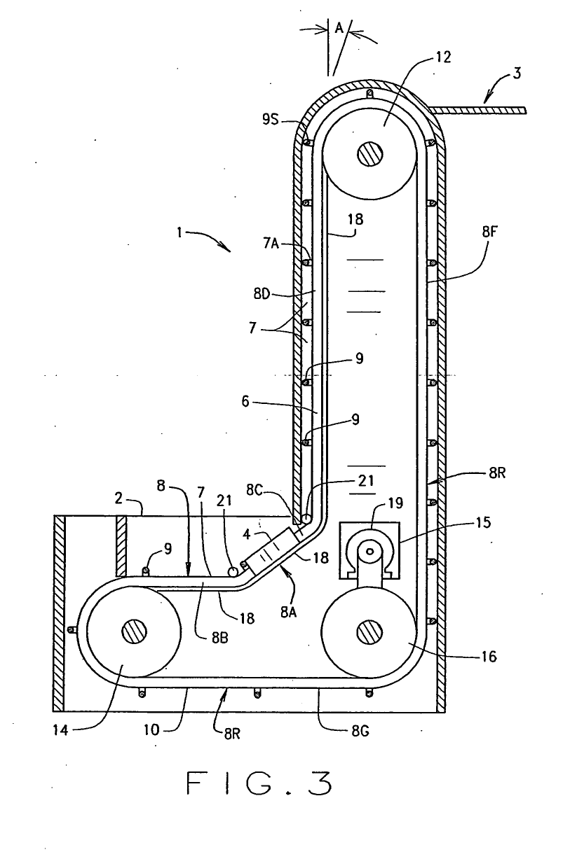

FIG. 3 is a fragmentary side sectional view showing portions of the conveyor system conveying container components.

FIG. 4 is a side sections view of the sorting apparatus shown in FIG. 1.

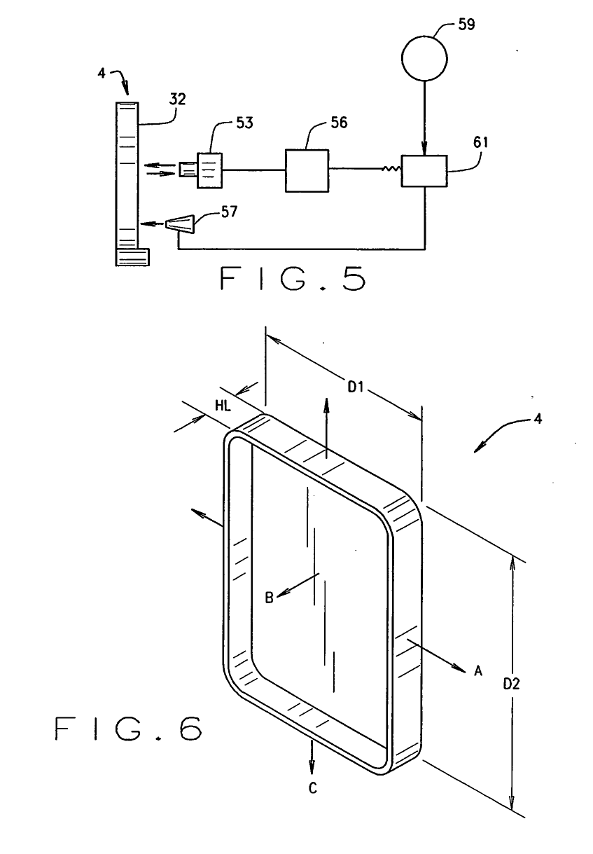

FIG. 5 is a simplified schematic of a control circuit.

FIG. 6 is a perspective view of a container lid.

Like numbers throughout the various figures represent like or similar parts or structure.

### DETAILED DESCRIPTION

FIG. 1 illustrates an orienting apparatus 1 that is operable for orienting container components. The apparatus 1 includes first and second orienting structure. The first orienting structure orients container components that are randomly oriented about three orthoganol axes, A, B, C, into a two axis orientation, namely axes A and C. The second orienting structure determines one of two possible orientations of the container components about axes C and A and ejects those that are determined to be improperly oriented as more fully described below. The then properly oriented container components are fed to a take away structure 3 for transfer to locations for downstream use or processing. The orienting apparatus 1 includes a receptacle 2, an orienting conveyor system 8, and a combination sensing and ejection system designated generally 5. Randomly oriented container components for example lids 4, are contained in bulk in the receptacle 2 and may be randomly oriented about three axes, A, B, C.

The receptacle 2 may be in the form of an open top hopper into which lids 4 may be dumped for temporary storage and sorting. In a preferred embodiment, the conveyor system 8 has a feed run segment 8A with a run 8B positioned adjacent the lower portion of the storage area of the receptacle 2 and has pockets 7 with an open side for receipt of lids 4 therein. Adjacent a trailing edge, 7A of each pocket 7, is a conveyor flight or link 9 that will engage container lids 4 which are lying generally in the plane of the feed run 8A and move them along the conveyor system 8 to the take away conveyor 3. The conveyor system 8 includes a plurality of run portions including generally the feed run 8A and the return run 8R, which are described hereinafter. The conveyor system 8 has run portions that move in different directions than the run 8B. The conveyor system 8 includes the conveyor device 10 which in a preferred form of invention is in the form of a scraper chain conveyor comprising a pair of chains 11L, and 11R plurality of transversely extending links 9 secured to and extending therebetween forming pockets 7 therebetween and along the length of the conveyor device 10. The conveyor device 10 is associated with the plurality of turning or redirecting devices such as pulleys, including an upper pulley assembly 12, a lower pulley assembly 14 and an intermediate pulley assembly 16. A power drive 15 is provided and is operably connected to the conveyor device 10 and is operable to move said conveyor device preferably in a continuous manner. Preferably the height H of each of the links 9 is substantially equal to or greater than the height HL of the lids 4. Herein, the operation and function of the apparatus 1 will be described in terms of processing lid components however it is to be understood that other container components may also be oriented with the device, including container receptacles or bottoms. The pulley assemblies 12, 14 and 16 engage the chains 11L, 11R. At least two of the pulley assemblies 12, 14 and 16 may be idler arrangements and can be driven by the chains 11 while at least one of the pulley assemblies is driven by power drive 15, for example, an electric motor. Such scraper chain conveyors and pulley assemblies are well known in the art. Tensioners, not shown, may also be provided to maintain the appropriate tension in the conveyor device 10 during operation. It is preferred, that the run 8A including runs 8B-D be in tension to maintain them adjacent to support panels 18 which are on the inside of the conveying device 10 and provides support for the lids 4 during movement on the conveying device 10. Typically, the pulleys 12, 14 and 16 are sprockets mounted to shafts which are in turn rotatably mounted to bearing arrangements to permit free rotation of the shafts and sprockets allowing low resistance movement of the conveyor device 10. In a preferred embodiment, the pulley assembly 16 is operably connected to a power drive 15, for example, an electric motor 19, while the pulley assemblies 12 and 14 can rotate freely and be driven by the chain's 11 each of which is engaged with respective pulleys on the pulley assemblies 12, 14. However, it is to be understood that any of the pulley arrangements 12, 14, 16 can be used to drive the conveyor device 10 and any of pulley assemblies 12, 14, 16 may be used to effect the power drive of the conveyor device 10.

The conveyor device 10, as discussed above, is preferably in the form of a scraper chain conveyor having a pair of chains 11 with links 9 connected to and extending therebetween. Each link 9 forms a pusher shoulder 9S which will engage a portion of the lid 4 to push lids that fall within the pockets 7 that are lying substantially in the planes of the portions of the run 8A. As the lids 4 are moved through the bottom portion of the receptacle 2, the plane of the conveyor device 10 and hence the plane of the lids 4 changes through a transition zone 8C for movement into the generally vertical run 8D. Idlers 21 engage the chains 11 to help effect the changes in direction between the runs 8B-D. The panels 18 define one side of and maintain the lids 4 within the pockets 7 formed between the chains 11 and the links 9. Once lids 4 are positioned within a pocket 7, and lie within the plane of the conveyor device 10, they are oriented in two axes A, C with orientation being one of two alternatives. In a preferred embodiment, apparatus 1 is particularly useful with container components that have a transverse dimension D or a pair of transverse dimensions, denoted D1, D2 for a generally rectangular container component, wherein D1, D2 are both preferably at least twice height HL of the lid 4. The height H of the link 9 is preferably substantially equal the height HL or may be greater than height HL of the lid 4. The container component, be it a lid 4 or a receptacle will have a side wall portion 31 and a top 32 or bottom wall portion defining a cavity 33. Thus, as the component is retained in a pocket 7 within the conveyor device 10 may have one of multiple orientations about axes A and C which is generally normal to the top 32 or bottom wall. In the case of a rectangular lid 4, lid 4 will generally be either in one of two orientations either standing up or lying down on its side seen in FIG. 2. A round container component may assume one of many rotational positions about axis B. Even a rectangular or multi-sided component may assume other than a standing up or lying down orientation resting on one of the four side edges which will be in engagement with a shoulder as of the respective link 9. Preferably, the conveyor run portion 8D preferably positions the lids 4 in a generally vertical orientation at least through sensing and the ejection zone 40. The conveying device 10 also includes and may be referred to as return runs 8F and 8G with being a direction between the two runs and the location of the pulley assembly 16. There may be idler pulley assemblies 21 at opposite ends of the transition zone 8C that help change the direction or the movement of the conveyor device 10. The transition zone 8C may provide a planar section or a curvilinear conveyor section. Thus, the conveyor device 10 and the backing panels 18 define the open sided pockets 7. While the scraper chain conveying device is shown, other conveyor devices may be utilized. The particular form of conveyor device 10 will depend upon the particular sensing and the ejection assembly 51 that is utilized. The conveyor device 10 may have panels moving with the conveyor device 10 to substitute for the panels 18 and be more in form of a traditional conveyor belt. The lids 4 move into the orientation sensing and ejection zone 40 what may be referred to as a right side out, right side in orientations about axes A and C as seen in FIG. 4. The sensing and ejection assembly 51 includes a sensor 53 that will determine whether or not the lid 4 is right side out or right side in. This may be simply done by the use of a photoelectric eye such as a background supression photoelectric eye which senses the location of the top wall 32. The assembly 51 can be programmed to send a signal in response to the wall 32 being on the inside or the outside of the path of lid movement. Depending on the programming, the lids 4 that are not in the proper orientation are then ejected or removed from the conveying device by operation of the ejector 55. The system 51 hereafter will be described as if the proper orientation is with the wall 32 being positioned on the inside. If the sensor 53 senses the wall 32 being on the outside, it will send a signal determined by a programmed logic circuit or a PLC 56 for example, an integral sensor control, to activate an ejector 55 mechanism. In the preferred embodiment, the ejector 55 includes an air nozzle 57 which is fed by a source 59 of compressed air with the air being controlled by both the sensor 53, the control circuit 56 and a valve 61. When a lid 4 needs ejected, a signal from through the circuit 57 activates valve 61 and impinges air on the lid 4 ejecting the lid from the conveying device 10. In a preferred embodiment, once a lid 4 is ejected, it may fall back into the hopper 3. Programming may also be provided to determine whether the object passing a sensor 53 is a link 9 or a lid 4 or a container component sidewall 31 as opposed to a top 32 or bottom wall. It should be understood that instead of a programmed circuit, the system could function with a hard wired circuit directly to the solenoid valve.

Referring to FIG. 4, the lids 4 will be oriented either correctly, or incorrectly, FIG. 4 shows the two possible orientations about axes A and C: correct orientation 108 and incorrect orientation 106. Correct and incorrect orientations are arbitrary and are determined by downstream needs. As the lids 4 are conveyed up the run 8D, they will pass over at least one orientation sensor 53. In the preferred embodiment, the orientation sensor is a photoeye; however, any device capable of sensing distance to an object will suffice, for example air gage, sonic detector or the like. The sensor 53 is configured so as to detect the orientation of the lids 4. If the lid is in the incorrect orientation 108, the sensor will effect a signal generation to activate an ejection device 55. In the preferred embodiment, the ejection device includes an air nozzle 57; however, any device capable of ejecting or a vacuum picker a container component off the run 8D will suffice, for example, a push rod. When the control valve 61 is activated, a burst of air will blow the incorrectly oriented lid 4 off of the run 8D. In a preferred embodiment, after the lids 4 are ejected they will fall back into the receptacle 2. However, the orientation apparatus 1 may also be designed so that the lids 4 fall or are moved somewhere other than back into the receptacle 2, for example an alternate conveyor system or an alternate receptacle. If the lid is in the correct orientation 108, the sensor 53 will not activate the valve 61 and the lid 4 will not be blown off of the run 8D. Thus, the present invention rejects incorrectly oriented container components, but allows correctly oriented container components to pass.

Each sensor 53 is shown directly above a respective air nozzle 57; however, the sensor 53 could also be above the respective air nozzle 57 or next to the air nozzle 57 and still be within the scope of the present invention. More than one are nozzle 57 and respective valve 61 may be sued to eject a lid 4. Further, a plurality of sensor 53 and air nozzles 57 are shown in FIGS. 1 and 2, but the number of sensors and air nozzles is not critical to the present invention. However, in a preferred embodiment, a plurality of sensors 57 and air nozzles 57 are spread out over the width of the zone 40 so that lids 4 will pass by at least one sensor 53 and at least one air nozzle 57 regardless of their transverse position on the run 8D.

As mentioned, many orientation sensors are within the scope of the present invention and the exact structure, type, or function is not important. However, the preferred orientation sensor 53 is a photo eye, described above. A suitable photoeye operates by emitting light and sensing any light that is reflected back. The emitted light is focused a specific distance from the photoeye that allows for detection of incorrectly oriented container lids 4. This focal range will vary according to the particular dimensions of the container components. When a lid 4 passes in front of a photo eye's emitted light beam and it is within the focal range of the emitted light, then the light is reflected back to the photoeye. The photoeye senses the light and triggers an electrical current signal as in the PLC. However, when a lid 4 passes in front of a photoeye's emitted light beam and is outside of the focal point of the light beam, then the light is dispersed and not reflected back to the photo eye. When the photo eye senses the reflected light, an electrical signal is sent to a solenoid of the valve 61. The solenoid, then, triggers the valve 61 to direct air to the respective air nozzle 57 from the air source 59. The air nozzle 57 emits a burst of air which blows an incorrectly oriented lid off of the run 8D.

The exact type or structure of the air nozzle 57 is not important and any type would be within the scope of the present invention. The only limitations are that the energy of the emitted air is enough to knock a container lid 4 off the run 8D, but not too much so that the container lid is blown away from the receptacle 2.

The inclined portion 102 of the device 1 is preferably nearly vertical or slightly off vertical, most preferably at an angle A of from about 0 to about 10 degrees of vertical, where 10 degrees is in the direction away from the receptacle 2. This angle ensures that the center of gravity of the lids 4 can be utilized. If the angle is nearly vertical or in the direction away from the receptacle, the center of gravity of the lids 4 will hold the lids on the flights 9.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for orienting container portions said apparatus comprising:
a receptacle for holding a plurality of container portions in random orientation about three axes;
a conveyor system adapted to remove container portions from the receptacle, said conveyor system including a conveyor device connected to a drive system for effecting movement of the conveyor device, said conveyor device having a feed run and a return run, said conveyor device having a plurality of flights spaced apart along the length of the feed and drive runs and pockets between the flights, a first portion of the feed run being positioned in the receptacle and a second portion extending generally upwardly from the receptacle and having a panel adjacent one side of the second portion of the feed run to support container portions thereon, said conveyor system having a container portion discharge said conveyor being operable to remove container components from the receptacle in two or less second axes of random orientation with orientation about a said second axis being in one of a first orientation and a second orientation;
an orientation sensor operable to sense orientation of a container portion being carried on the feed run second portion and generate an ejection signal if a container portion is in a said first orientation;
an ejection device operably connected to the sensor and receive the rejection signal and operable to eject a container component from the feed run second portion in response to receipt of an ejection signal; and
a second conveyor system adapted to receive non ejected container components from the feed run.

2. The apparatus of claim 1 wherein the ejection device is operable to eject a rejected container back into the receptacle.

3. The apparatus of claim 2 wherein the sensor including a photoeye.

4. The apparatus of claim 3 wherein the rejection device including an air nozzle connected in flow communication with a flow control valve.

5. The apparatus of claim 4 wherein the flow control valve being operably connected to the photoeye.

6. The apparatus of claim 5 wherein there being a plurality of photoeyes, a plurality of air nozzles and each in spaced apart relation transversely across the conveyor device, each photoeye being operable to control air flow through a respective said air nozzle.

7. The apparatus of claim 1 wherein the conveyor device including a scraper chain conveyor with the pockets being formed between a pair of chains having a plurality of longitudinally spaced apart links secured to and extending transversely between the chains, said links forming at least some of said flights, said panel being mounted to a support structure generally in a fixed relation thereto.

8. The apparatus of claim 7 wherein the conveyor device including a transition run portion positioned movement wise between a feed run and a generally vertical run.

9. A method of orienting container portions from a supply of randomly oriented container components randomly oriented about three axes, the method comprising:
withdrawing container components with a power driven conveyor device from a supply of container components with each withdrawn container component being oriented in a first orientation or a second orientation about an axis and resting on a conveyor flight;
conveying each of the withdrawn container components along a generally vertical path past a sensor and sensing whether a container component is in a first orientation or second orientation and sending an ejection signal to an ejector device if the sensed container component is in a first orientation;
ejecting a container component if it is in a first orientation in response to generating an ejection signal;
returning an ejected container portion to the supply; and
removing container components in the second orientation from the conveying device and conveying them to a location of use.

10. The method of claim 9 including returning at least some of the ejected container components to the supply.

11. The method of claim 10 wherein the returning is done by the ejected container components falling into the supply.

12. The method of claim 9 wherein the sensing includes projecting light on a container component and reading reflected light.

13. The method of claim 12 wherein the ejecting includes impinging a jet of air on a container component to be ejected.

14. The method of claim 9 wherein the withdrawn container components being randomly oriented about a first axis normal to a top or bottom panel and oriented in one of the first or second orientations about a second axis generally normal to the first axis.

15. The method of claim 14 wherein the container component having a transverse dimension at least two times longer than a container component height.

16. The method of claim 15 wherein the container components being container lids.
